(19) United States
(12) Patent Application Publication
(10) Pub. No.: US 2025/0307305 A1
(43) Pub. Date: Oct. 2, 2025

(54) SYSTEM AND METHOD FOR DYNAMIC CONTENT ADAPTATION FOR SAFE DRIVING

(71) Applicant: TiVo Platform Technologies LLC, San Jose, CA (US)

(72) Inventors: Vasanth Raj RAJANNA, Bangalore (IN); Govind RAVEENDRANATHAN NAIR, Bangalore (IN); Anil KUMAR, Bangalore (IN); Sangeeta PARIDA, Bangalore (IN)

(21) Appl. No.: 19/090,922

(22) Filed: Mar. 26, 2025

Related U.S. Application Data
(60) Provisional application No. 63/570,121, filed on Mar. 26, 2024.

(51) Int. Cl. G06F 16/45; B60K 35/29; B60W 40/09

(52) U.S. Cl. CPC G06F 16/45; B60K 35/29; B60W 40/09; B60K 2360/164

(57) ABSTRACT

A database management method for dynamic content adaptation for safe driving is disclosed. The method includes receiving vehicle driving data and analyzing the received vehicle driving data to determine one or more parameters pertaining to dangerous driving. Further, the method includes determining media content being played at each instance corresponding to the determined one or more parameters and fetching metadata corresponding to the determined media content. Thereafter, the method includes mapping, in a database, a type of media content based on the fetched metadata with the determined one or more parameters for dynamic content adaptation to modify and/or block media content recommendations for safe driving.

### CROSS-REFERENCE TO RELATED APPLICATIONS

The present application claims the benefit of the filing date of U.S. Provisional Patent Application No. 63/570,121, filed on Mar. 26, 2024, the disclosure of which is hereby incorporated by reference.

### BACKGROUND

### Technical Field

The present disclosure relates to the field of safety and entertainment systems in vehicles and particularly relates to a system and method for dynamic content adaptation for safe driving.

### Description of the Related Art

Infotainment systems play a significant role in modern vehicles, offering a blend of entertainment, information, and connectivity. Apart from providing valuable information such as traffic updates and weather forecasts, such a system also provides entertainment, comfort, and convenience, thus making journeys, especially long journeys, more enjoyable. In terms of entertainment, such systems offer a wide range of media content, including music, podcasts, and videos, along with connectivity options like Bluetooth, enabling passengers to connect their devices and stream content in the vehicle.

Although such systems provide entertainment during journeys, but can also sometimes lead to distractions and unsafe driving behavior. One common scenario is when a driver becomes excited or stimulated by the media content being played on the infotainment system, which can lead to changes in their driving pattern. For example, a driver may become more aggressive or erratic in their driving, leading to an increased risk of accidents. Currently, there are no mechanisms available to monitor such behavior and adjust the content recommendations accordingly. This can result in a dangerous situation where drivers are exposed to content that may further exacerbate their distracted driving.

Therefore, there is a need for a dynamic content adaptation mechanism that modifies and/or blocks media content before it is played on an infotainment system of the vehicle for safe driving and overcomes the above-mentioned drawbacks.

### BRIEF SUMMARY

One or more embodiments are directed to a database management system and method for dynamic content adaptation for safe driving. Further, one or more embodiments are directed to a dynamic content adaptation system and method for safe driving. The present disclosure provides mechanisms for enhancing driving safety by dynamically adapting media content played on infotainment systems in vehicles since they can lead to distractions and unsafe driving behaviors. In order to address such issues, the present disclosure proposes two main aspects building a database of media content that can contribute to dangerous driving and using this database to modify or block such content from playing in the vehicle.

In an embodiment, the first aspect involves a database management system that analyzes vehicle driving data, such as speed, acceleration, and steering wheel movements, to determine parameters of dangerous driving. The database management system then correlates this data with media content metadata, such as genre and volume, to build a database of potentially risky content. The database serves as a foundation for the system to make informed decisions about modifying or blocking media content.

In an embodiment, the second aspect involves a dynamic content adaptation system that receives media content to be played on the infotainment system. The dynamic content adaptation system fetches metadata for the content and identifies its type, then correlates this information with the database to determine if the content is potentially dangerous while driving. If so, the dynamic content adaptation system can modify the content by adjusting volume or speed, muting, skipping, pausing, or stopping it altogether to reduce distractions and promote safer driving behaviors. Accordingly, the present disclosure aims to improve road safety by dynamically adapting media content based on driving conditions. By proactively identifying and addressing potentially risky content, it helps minimize distractions for drivers, making journeys safer and more enjoyable.

An embodiment of the present disclosure discloses the database management system for dynamic content adaptation for safe driving. The database management system includes a receiver module to receive vehicle driving data. The vehicle driving data corresponds to speed, acceleration, deceleration, steering wheel movements, location, turn signal, brakes, horn, camera, collision sensors, and/or dippers. In an embodiment, the database management system includes an analyzer module to analyze the received vehicle driving data to determine one or more parameters pertaining to dangerous driving. To determine the one or more parameters pertaining to dangerous driving, the analyzer module is further configured to compare the received vehicle driving data with normal vehicle driving data. The one or more parameters include overspeeding, frequent lane changing, multiple collision warnings, sudden acceleration, frequent use of brakes, excessing honking, and/or excessive use of dippers. It may be apparent to a person skilled in the art that the normal vehicle driving data may dynamic and may depend on conditions such as, but not limited to, weather (e.g., different for rainy and sunny conditions), type of vehicle (e.g., different for off-roading vehicle and a sedan), congestion on road (e.g., different for traffic jams and clear roads), road conditions (e.g., different for smooth road and road with potholes), type of road (e.g., different for cities and highways), or the like.

In an embodiment, the database management system includes a content monitoring module to determine media content being played at each instance corresponding to the determined one or more parameters. Upon determination, the content monitoring module fetches metadata corresponding to the determined media content. In an embodiment, the database management system includes a database building module to map, in a database, a type of media content based on the fetched metadata with the determined one or more parameters for dynamic content adaptation to modify and/or block media content recommendations for safe driving. The type of media content corresponds to genre, singer, album, volume, intensity, title, duration, and/or repetitiveness.

An embodiment of the present disclosure discloses the database management method for dynamic content adaptation for safe driving. The database management method includes the steps of receiving vehicle driving data. The vehicle driving data corresponds to speed, acceleration, deceleration, steering wheel movements, location, turn signal, brakes, horn, camera, collision sensors, and/or dippers. Further, the database management method includes the steps of analyzing the received vehicle driving data to determine one or more parameters pertaining to dangerous driving. To determine the one or more parameters pertaining to dangerous driving, the database management method includes the steps of comparing the received vehicle driving data with normal vehicle driving data. The one or more parameters include overspeeding, frequent lane changing, enabling collision warnings, sudden acceleration, frequent use of brakes, excessing honking, and/or excessive use of dippers.

The database management method also includes the steps of determining media content being played at each instance corresponding to the determined one or more parameters. Upon determining the media content, the database management method includes the steps of fetching metadata corresponding to the determined media content. Thereafter, the database management method includes the steps of mapping, in a database, a type of media content based on the fetched metadata with the determined one or more parameters for dynamic content adaptation to modify and/or block media content recommendations for safe driving. The type of media content corresponds to genre, singer, album, volume, intensity, title, duration, and/or repetitiveness.

An embodiment of the present disclosure discloses the dynamic content adaptation system for safe driving. The dynamic content adaptation system includes a receiver module to receive media content to be played on an infotainment system of a vehicle and fetch metadata corresponding to the received media content. The media content is received from a content provider, an Over-The-Top (OTT) platform, a content broadcaster, a third-party device, a Frequency Modulation (FM) broadcaster, and/or an Amplitude Modulation (AM) broadcaster.

In an embodiment, the dynamic content adaptation system includes a content identification module to identify a type of media content based at least on the fetched metadata. In one scenario, when the media content is received from the content provider, the Over-The-Top (OTT) platform, the content broadcaster, and/or the third-party device, then the fetched metadata for identifying the type of media content includes embedded srt file, embedded teletext, title details, artist details, genre details, time details, and/or intensity details. In another scenario, when the media content is received from the FM broadcaster and/or the AM broadcaster, then the content identification module is further configured to add a delay of a pre-defined time interval before the media content is played on the infotainment system of the vehicle, analyze the media content by audio decoding of the media content, video decoding of the media content, audio decoding of introductory content by Radio Jockey (RJ), and/or video decoding of introductory content by Video Jockey (VJ), and identify the type of media content based on the analyzed media content.

In an embodiment, the dynamic content adaptation system includes a content blocking module to correlate the type of media content with one or more types of media content stored in a database. Upon correlating, the content blocking module identifies the media content to be played as a potentially dangerous media content while driving. In an embodiment, the dynamic content adaptation system includes a rendering module to modify and block the identified media content from rendering on the infotainment system of the vehicle for safe driving. The modification of the identified media content before rendering on the infotainment system of the vehicle for safe driving corresponds to decreasing volume, increasing volume, increasing speed, decreasing speed, muting, skipping the identified media content, pausing, and/or stopping.

In an embodiment, the database is built by a database management system. Firstly, the database management system receives vehicle driving data. Further, the database management system analyzes the received vehicle driving data to determine one or more parameters pertaining to dangerous driving. The database management system analyzes determining media content being played at each instance corresponding to the determined one or more parameters and fetches metadata corresponding to the determined media content. Thereafter, the database management system maps, in the database, a type of media content based on the fetched metadata with the determined one or more parameters for dynamic content adaptation to modify and/or block media content recommendations for safe driving.

The disclosed system and method (together termed as ‘disclosed mechanism’) for dynamic content adaptation for safe driving overcomes the drawbacks of the present technologies and offers several other advantages in enhancing driving safety and reducing distractions caused by media content in the vehicles. By analyzing vehicle driving data and correlating it with media content metadata, the mechanism can proactively identify potentially dangerous content which allows for the modification or blocking of such content before it is played, reducing the risk of distractions and unsafe driving behaviors. Further, the mechanism's ability to dynamically adapt media content based on driving conditions promotes a safer driving environment. For example, the system can adjust the volume or speed of media content to minimize distractions without completely stopping the entertainment experience. This ensures that drivers remain engaged with the infotainment system while staying focused on the road. Additionally, the database of dangerous driving parameters and corresponding media content types can be continuously updated and refined which means that the mechanism can adapt to new types of media content or driving behaviors, ensuring that it remains effective in mitigating distractions and promoting safe driving practices over time. Overall, the mechanism's combination of data analysis, content identification, and adaptive control mechanisms offers a comprehensive solution for enhancing driving safety in vehicles with infotainment systems. It addresses the challenge of balancing entertainment and safety by providing a dynamic and proactive approach to managing media content during journeys.

The features and advantages of the subject matter here will become more apparent in light of the following detailed description of selected embodiments, as illustrated in the accompanying FIGURES. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary environment for dynamic content adaptation for safe driving, in accordance with an embodiment of the present disclosure.

FIG. 2 illustrates a block diagram of a database management system for dynamic content adaptation for safe driving, in accordance with an embodiment of the present disclosure.

FIGS. 3A-3B illustrate an exemplary instance of mapping a media content with vehicle driving data in a database, in accordance with an embodiment of the present disclosure.

FIG. 4 illustrates a block diagram of a dynamic content adaptation system for dynamic content adaptation for safe driving, in accordance with an embodiment of the present disclosure.

FIG. 5A illustrates an exemplary instance of blocking a potentially dangerous media content from playing on an infotainment system of the vehicle, in accordance with an embodiment of the present disclosure.

FIG. 5B illustrates an exemplary implementation of blocking a potentially dangerous FM/AM media content from playing on the infotainment system of the vehicle, in accordance with an embodiment of the present disclosure.

FIG. 5C illustrates an exemplary instance of playing the potentially dangerous media content on an infotainment system of the vehicle when the vehicle is not moving, in accordance with an embodiment of the present disclosure.

FIG. 5D illustrates an exemplary instance of blocking the potentially dangerous media content from playing on an infotainment system of the vehicle when the vehicle is moving, in accordance with an embodiment of the present disclosure.

FIG. 6 is a flow chart of a database management method for dynamic content adaptation for safe driving, in accordance with an embodiment of the present disclosure.

FIG. 7 is a flow chart of a dynamic content adaptation method for safe driving, in accordance with an embodiment of the present disclosure.

FIG. 8 illustrates an exemplary computer unit in which or with which embodiments of the present disclosure may be utilized.

Other features of embodiments of the present disclosure will be apparent from accompanying drawings and detailed description that follows.

### DETAILED DESCRIPTION

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, magnetic tape, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other types of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within the single computer) and storage systems containing or having network access to a computer program(s) coded in accordance with various methods described herein, and the method steps of the disclosure could be accomplished by modules, routines, subroutines, or subparts of a computer program product.

### Terminology

Brief definitions of terms used throughout this application are given below.

The terms “connected” or “coupled”, and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

Embodiments of the present disclosure relate to a system and method for a database management system and method for dynamic content adaptation for safe driving. Further, one or more embodiments are directed to a dynamic content adaptation system and method for safe driving. The present disclosure provides mechanisms for enhancing driving safety by dynamically adapting media content played on infotainment systems in vehicles since they can lead to distractions and unsafe driving behaviors. In order to address such issues, the present disclosure proposes two main aspects i.e., building a database of media content that can contribute to dangerous driving, and using the built database to modify or block such content from playing in the vehicle.

FIG. 1 illustrates an exemplary environment 100 for dynamic content adaptation for safe driving, in accordance with an embodiment of the present disclosure. In an embodiment, the exemplary environment 100 may include a media content 102, a network 104, a database management system 106, a dynamic content adaptation system 108, and an infotainment system 110. The media content 102 may be received onto the network 104 from a content provider, Over-The-Top (OTT) platform, content broadcaster, a third-party device, Frequency Modulation (FM) broadcaster, and Amplitude Modulation (AM) broadcaster. Such media content 102 may be received for the purpose of rendering on the infotainment system 110 of the vehicle.

In an embodiment, the infotainment system 110 in the vehicle may correspond to a multimedia system that combines information and entertainment features. The infotainment system 110 may typically include a touchscreen display that provides access to various functions such as navigation, music, phone calls, and vehicle settings. Furthermore, the infotainment system 110 may support connectivity options like Bluetooth and USB, allowing users to connect their smartphones or other devices. The infotainment system 110 may enhance the driving experience by providing entertainment, navigation, and connectivity features, making long journeys more enjoyable and convenient. Accordingly, it may be apparent to a person skilled in the art that the media content 102 may correspond to any audio content or video content, such as songs, movies, TV shows, sports, FM radio, AM radio, HD radio, or the like. Further, the third-party device may be, without any limitation, a television, a streaming device, a mobile phone, a tablet, a computer, or any other multimedia player that may facilitate the user to play the media content 102. Furthermore, the network 104 (such as a communication network) may, without any limitation, include a direct interconnection, a Local Area Network (LAN), a Wide Area Network (WAN), a wireless network (e.g., using Wireless Application Protocol), the Internet, Bluetooth, Wireless Fidelity (Wi-Fi), Universal Serial Bus (USB) connectivity, or another connectivity infrastructure.

In an embodiment, the database management system 106 may analyze vehicle driving data, such as speed, acceleration, and steering wheel movements, to determine parameters of dangerous driving. When dangerous driving is identified, then the database management system 106 may correlate the determined parameters with media content metadata, such as genre and volume, to build a database of potentially risky content. Such built database may serve as a foundation to make informed decisions about modifying or blocking the media content 102. During operation, the dynamic content adaptation system 108 may receive the media content 102 to be played on the infotainment system and fetch metadata for the media content 102 to identify the type of media content. Upon determining the type of media content 102, the dynamic content adaptation system 108 correlates the type of media content 102 with the built database to determine if the media content 102 is potentially dangerous while driving. If so, the dynamic content adaptation system 108 may modify the media content 102 by adjusting volume or speed, muting, skipping, pausing, or stopping it altogether to reduce distractions and promote safer driving behaviors. Accordingly, the environment 100 may improve road safety by dynamically adapting media content based on driving conditions. By proactively identifying and addressing potentially risky content, the environment 100 may help minimize distractions for drivers, making journeys safer and more enjoyable. In an embodiment, such database management system 106 and the dynamic content adaptation system 108 may be implemented on the infotainment system 110 of the vehicle. In an embodiment, such database management system 106 and the dynamic content adaptation system 108 may be implemented on the content provider application of the OTT platform. In an embodiment, such database management system 106 and the dynamic content adaptation system 108 may be implemented on the third-party device (such as a mobile phone) connected to the infotainment system 110 of the vehicle.

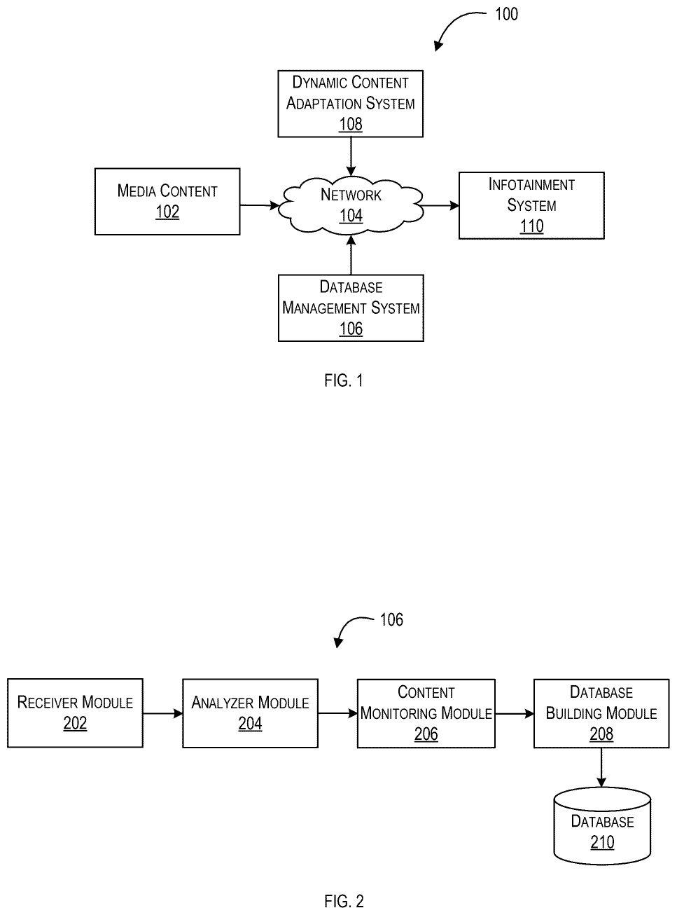

FIG. 2 illustrates a block diagram of a database management system 106 for dynamic content adaptation for safe driving, in accordance with an embodiment of the present disclosure.

In an embodiment, the database management system 106 may include a receiver module 202, an analyzer module 204, a content monitoring module 206, a database building module 208, and a database 210. The receiver module 202, the analyzer module 204, the content monitoring module 206, the database building module 208, and the database 210 may be communicatively coupled to a memory and a processor of the database management system 106. The processor may be configured to control the operations of the receiver module 202, the analyzer module 204, the content monitoring module 206, the database building module 208, and the database 210. In an embodiment of the present disclosure, the processor and the memory may form a part of a chipset installed in the database management system 106. In another embodiment of the present disclosure, the memory may be implemented as a static memory or a dynamic memory. In an example, the memory may be internal to the database management system 106, such as an onside-based storage. In another example, the memory may be external to the database management system 106, such as cloud-based storage. Further, the processor may be implemented as one or more microprocessors microcomputers, microcomputers, digital signal processors, central processing units, state machines, logic circuitries, and/or any devices that manipulate signals based on operational instructions.

In an embodiment, the receiver module 202 may receive vehicle driving data. The vehicle driving data may correspond to speed, acceleration, deceleration, steering wheel movements, location, turn signal, brakes, horn, camera, collision sensors, and/or dippers. It may be apparent to a person skilled in the art that such vehicle driving data may be received from one or more on-board sensors, vehicle diagnostic port, connected vehicle services, embedded systems, aftermarket devices (such as OBD dongles), or a combination thereof, without departing from the scope of the present disclosure.

In an embodiment, the analyzer module 204 may analyze the received vehicle driving data to determine one or more parameters pertaining to dangerous driving. To determine the one or more parameters pertaining to dangerous driving, the analyzer module 204 may compare the received vehicle driving data with normal vehicle driving data. The one or more parameters may include overspeeding, frequent lane changing, enabling collision warnings, sudden acceleration, frequent use of brakes, excessing honking, and/or excessive use of dippers. For example, consider a situation where the analyzer module 204 receives vehicle driving data indicating that the vehicle is consistently traveling at a speed significantly higher than the speed limit on a particular road. It may be apparent to a person skilled in the art that the normal vehicle driving data may dynamic and may depend on conditions such as, but not limited to, weather (e.g., different for rainy and sunny conditions), type of vehicle (e.g., different for off-roading vehicle and a sedan), congestion on road (e.g., different for traffic jams and clear roads), road conditions (e.g., different for smooth road and road with potholes), type of road (e.g., different for cities and highways), or the like. By comparing this data with normal driving patterns or predefined thresholds, the analyzer module 204 may identify this behavior as overspeeding, which is a parameter pertaining to dangerous driving.

In an embodiment, the content monitoring module 206 may determine media content being played at each instance corresponding to the determined one or more parameters. Upon determination, the content monitoring module 206 may fetch metadata corresponding to the determined media content. For example, the vehicle driving data indicates sudden acceleration and changing of lanes frequently pertaining to aggressive driving, then the content monitoring module 206 determines the media content being played at that time and fetches metadata corresponding to it, such as a high-energy, fast-paced music, slow sleepy music, singer's name, length of the music, genre, or name of the music.

In an embodiment, the database building module 208 to map, in the database 210, a type of media content based on the fetched metadata with the determined one or more parameters for dynamic content adaptation to modify and/or block media content recommendations for safe driving. The type of media content may correspond to genre, singer, volume, intensity, title, duration, and/or repetitiveness. Accordingly, the database building module 208 may create a comprehensive record that links specific types of media content with the identified parameters of dangerous driving, such as Song A leads to overspeeding, Song B leads to sleepiness, genre A leads to rash driving, Artist A leads to excessive acceleration or the like. Such database 210 may serve as a foundation for making informed decisions about modifying or blocking media content recommendations. For example, if the database 210 indicates that certain types of music or intense videos are associated with increased instances of aggressive driving, then that media content may be modified or blocked to reduce distractions and promote safer driving behaviors. In an embodiment, the database 210 may be used to stop potentially dangerous or provoking media content from being played when the user is driving and/or omit such media content from the playlist(s) that may be played during the driving of the vehicle.

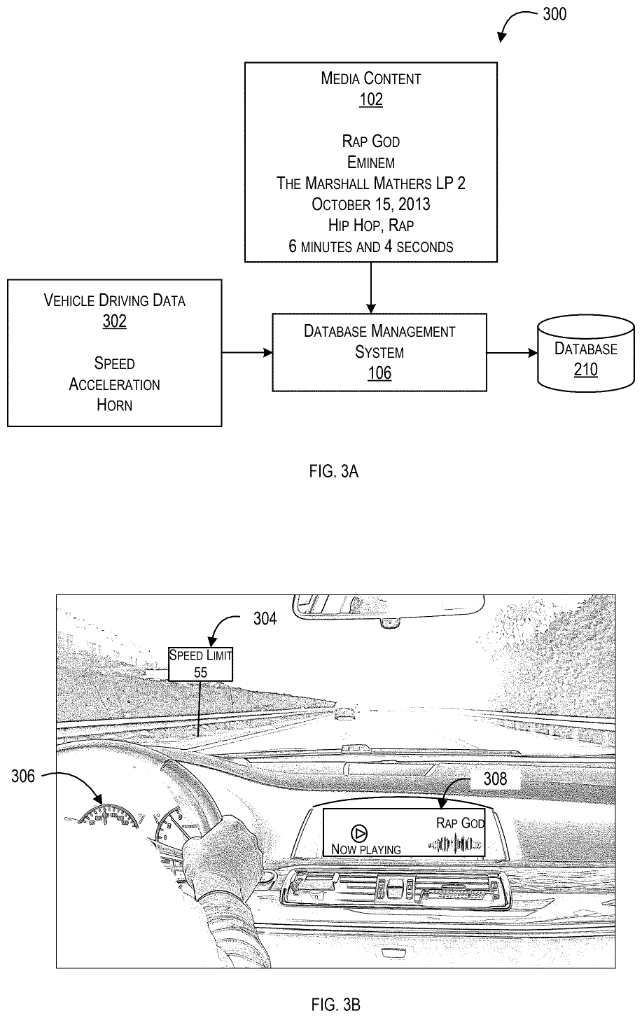

FIGS. 3A-3B illustrate an exemplary instance 300 of mapping the media content 102 with the vehicle driving data 302 in the database 210, in accordance with an embodiment of the present disclosure. In an embodiment, when the vehicle is being driven, the database management system 106 may receive the vehicle driving data 302 pertaining to excessive speed, acceleration, and/or honking. The database management system 106 may analyze the received vehicle driving data 302 to identify dangerous driving and may determine the media content 102 being played on the infotainment system of the vehicle. For instance, the media content 102 being played may be the song Rap God® by Eminem. The database management system 106 may fetch metadata pertaining to the determined media content being played, such as album name i.e., The Marshal Mathers LP2, release data i.e., Oct. 15, 2013, Genre i.e., Hip Hop—Rap, and length of the media content i.e., 6 minutes 4 seconds. The database management system 106 may map such media content based on the fetched metadata to dangerous driving in the database 210. Such mapping may correspond to exact mapping (i.e., Rap God—Dangerous driving), genre mapping (i.e., Hip Hop, Rap—Rash driving), and artist (i.e., Eminem—Speeding).

In an embodiment, as illustrated in FIG. 3B, the vehicle may be overspeeding, i.e., the speed limit may be 55 km/hr and the vehicle may be driven at a speed of 100 km/hr, as shown by 304 and 306. In such a scenario, the database management system 106 may receive the vehicle driving data 302 pertaining to current speed of the vehicle and the speed limit of the road. The database management system 106 may analyze the received vehicle driving data 302 to identify dangerous driving pertaining to overspeeding and may determine the media content 102 being played on the infotainment system of the vehicle i.e., the song Rap God® by Eminem, as shown by an interface 308 in FIG. 3B. The database management system 106 may fetch metadata pertaining to the determined media content being played and may map such media content based on the fetched metadata to dangerous driving in the database 210. Accordingly, such media content may not be played when the user is driving and/or such media content may be omitted from the playlist(s) that may be played during the driving of the vehicle.

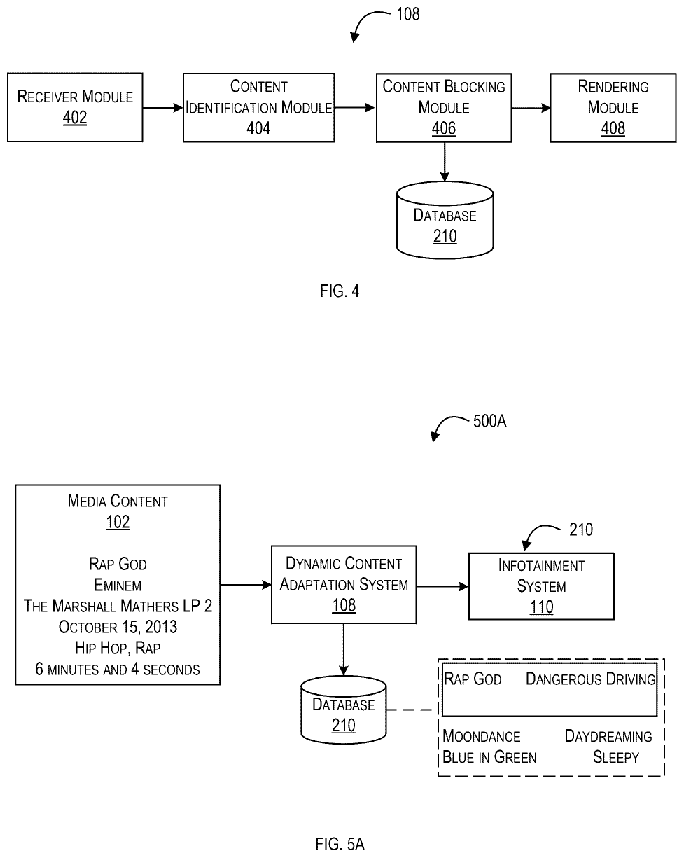

FIG. 4 illustrates a block diagram of a dynamic content adaptation system 108 for dynamic content adaptation for safe driving, in accordance with an embodiment of the present disclosure.

In an embodiment, the dynamic content adaptation system 108 may include a receiver module 402, a content identification module 404, a content blocking module 406, a rendering module 408, and the database 210. The receiver module 402, the content identification module 404, the content blocking module 406, the rendering module 408, and the database 210 may be communicatively coupled to a memory and a processor of the dynamic content adaptation system 108. The processor may be configured to control the operations of the receiver module 402, the content identification module 404, the content blocking module 406, the rendering module 408, and the database 210. In an embodiment of the present disclosure, the processor and the memory may form a part of a chipset installed in the dynamic content adaptation system 108. In another embodiment of the present disclosure, the memory may be implemented as a static memory or a dynamic memory. In an example, the memory may be internal to the dynamic content adaptation system 108, such as an onside-based storage. In another example, the memory may be external to the dynamic content adaptation system 108, such as cloud-based storage. Further, the processor may be implemented as one or more microprocessors microcomputers, microcomputers, digital signal processors, central processing units, state machines, logic circuitries, and/or any devices that manipulate signals based on operational instructions.

In an embodiment, the receiver module 402 may receive the media content 102 to be played on the infotainment system 210 of the vehicle and fetch metadata corresponding to the received media content. In one scenario, the media content 102 may be received directly from content providers such as music streaming services, video streaming platforms, or online radio stations which typically offer APIs or feeds that allow the receiver module 402 to access the content and its metadata. In another scenario, the media content 102 may be received from an Over-The-Top (OTT) platform that delivers the media content over the internet, bypassing traditional distribution channels that allow the receiver module 402 to access content from OTT platforms through their APIs or streaming protocols. In yet another scenario, the media content 102 may be received from the content broadcaster, Frequency Modulation (FM) broadcaster, and/or Amplitude Modulation (AM) broadcaster over the airwaves, such that the receiver module 402 may capture the media content using radio receivers and extract metadata from broadcast signals. In yet another scenario, the media content 102 may be received from a third-party device, such as smartphones, tablets, or media players, connected to the infotainment system 110 through wired or wireless connections, such as Bluetooth or USB.

In an embodiment, the content identification module 404 may identify a type of media content based on the fetched metadata. In one scenario, when the media content 102 is received from the content provider, Over-The-Top (OTT) platform, content broadcaster, and/or a third-party device, then the fetched metadata for identifying the type of media content may include embedded srt file, embedded teletext, title details, artist details, genre details, time details, and/or intensity details. In one example, the content identification module 404 may analyze metadata such as artist, album, and genre to categorize the music into specific genres such as pop, rock, or classical. In another example, the content identification module 404 may analyze metadata such as title, description, and keywords to determine the genre or type of video, such as movie, documentary, or music video. In yet another example, the content identification module 404 may analyze metadata such as title, description, and episode information to categorize the podcast into genres such as news, comedy, or education. In another scenario, when the media content 102 is received from the FM broadcaster and/or the AM broadcaster, then the content identification module 404 may add a delay of a pre-defined time interval before the media content 102 is played on the infotainment system of the vehicle, analyze the media content 102 by audio decoding of the media content, video decoding of the media content 102, audio decoding of introductory content by Radio Jockey (RJ), and/or video decoding of introductory content by Video Jockey (VJ), and identify the type of media content based on the analyzed media content.

In an embodiment, the content blocking module 406 may correlate the type of media content with one or more types of media content stored in the database 210. Upon correlating, the content blocking module 406 may identify the media content 102 to be played as a potentially dangerous media content while driving. Accordingly, the content blocking module 406 correlates and identifies potentially dangerous media content by comparing the type of media content received with the database 210 of known risky media content based on the mapping of media content types with parameters of dangerous driving that may be previously established by the database management system 106. For example, if the database 210 indicates that high-tempo music is associated with aggressive driving behavior, the content blocking module 406 may identify a fast-paced music track as potentially dangerous. Similarly, if the database 406 indicates that certain types of videos are linked to distracted driving, the content blocking module 406 may flag such videos as risky.

In an embodiment, the rendering module 408 may be responsible for managing the playback of the media content 102 on the infotainment system 110 of the vehicle. Further, the rendering module 408 may modify and/or block the identified media content from rendering on the infotainment system 210 based on the assessment of its potential impact on driving safety for safe driving. To modify the media content, the rendering module 408 may adjust parameters such as volume, playback speed, or visual display settings. Further, the modification of the identified media content before rendering on the infotainment system 110 may correspond to decreasing volume, increasing volume, increasing speed, decreasing speed, muting, skipping the identified media content, pausing, and/or stopping. For example, the rendering module 408 may reduce the volume of loud music or speed up the playback of long videos to minimize distractions. Further, in order to block the media content, the rendering module 408 may skip or pause the media content entirely. It may be apparent to a person skilled in the art that the rendering module 408 may also prevent certain types of media content from being played altogether based on predefined rules or real-time analysis of driving conditions.

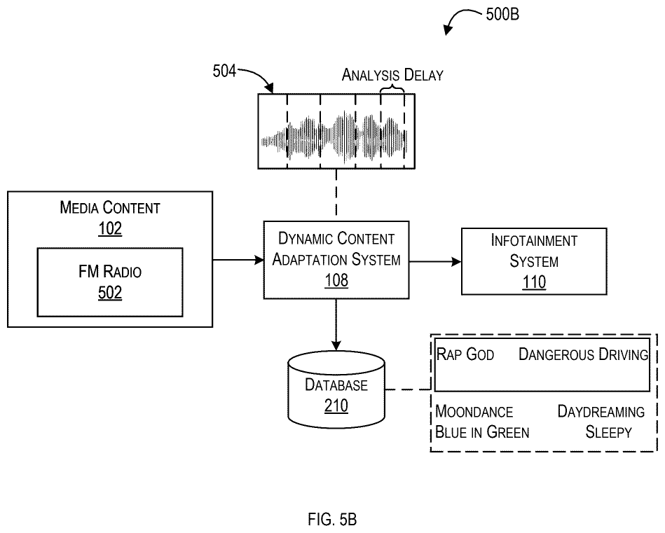

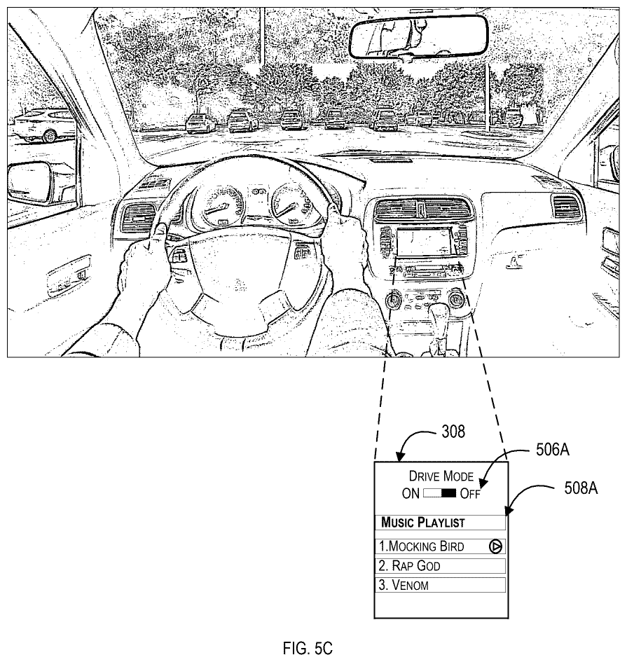

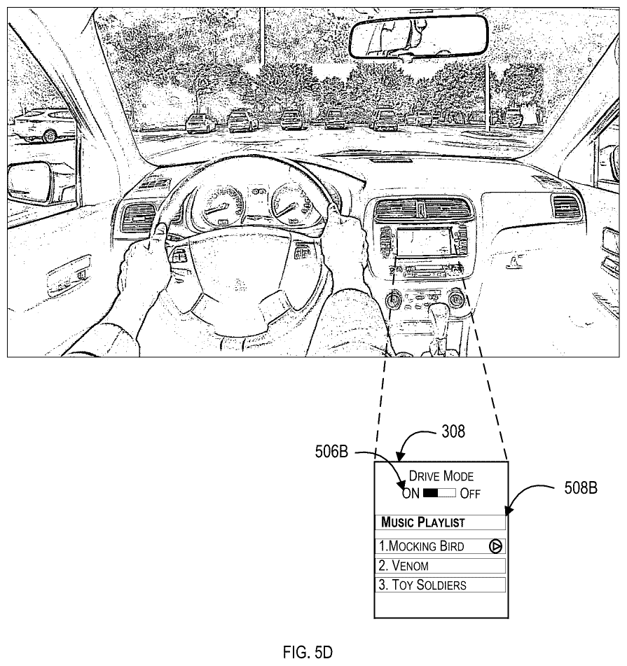

FIG. 5A illustrates an exemplary instance 500A of blocking a potentially dangerous media content from playing on an infotainment system of the vehicle, in accordance with an embodiment of the present disclosure. FIG. 5B illustrates an exemplary implementation 500B of blocking a potentially dangerous FM/AM media content from playing on the infotainment system of the vehicle, in accordance with an embodiment of the present disclosure. FIG. 5C illustrates an exemplary instance of playing the potentially dangerous media content on an infotainment system of the vehicle when the vehicle is not moving, in accordance with an embodiment of the present disclosure. FIG. 5D illustrates an exemplary instance of blocking the potentially dangerous media content from playing on an infotainment system of the vehicle when the vehicle is moving, in accordance with an embodiment of the present disclosure. For the sake of brevity, FIGS. 5A and 5D have been explained together.

In an embodiment, as illustrated in FIG. 5A, when the vehicle is being driven, the dynamic content adaptation system 108 may receive the media content 102 being played on the infotainment system of the vehicle. For instance, the media content 102 being played may be the song Rap God® by Eminem. The dynamic content adaptation system 108 may fetch metadata pertaining to the determined media content being played, such as album name i.e., The Marshal Mathers LP2, release data i.e., Oct. 15, 2013, Genre i.e., Hip Hop—Rap, and length of the media content i.e., 6 minutes 4 seconds. Upon fetching the metadata, the dynamic content adaptation system 108 may identify the type of media content based on the fetched metadata, such as genre, associated artist, time, or the like. Based on the identified type of media content, the dynamic content adaptation system 108 may correlate the type of media content with the one or more type of media contents stored in the database 210 to identify if the media content 102 to be played is a potentially dangerous media content or not. The media content 102 is only rendered on the infotainment system 110 of the vehicle if the media content 102 is not mapped in the database 210 and if the media content is mapped in the database 210 then the media content 102 is either modified (such as reduction of volume) before playing or blocking from playing on the infotainment system 110 of the vehicle.

In an embodiment, as illustrated in FIG. 5B, when the media content 102 received to be played on the infotainment system 110 of the vehicle is received from the FM broadcaster and/or the AM broadcaster i.e., FM radio 502, then the dynamic content adaptation system 108 may add a delay of a pre-defined time interval before the media content 102 is played on the infotainment system 110 of the vehicle. Upon adding the delay, the dynamic content adaptation system 108 may analyze the media content 102 by either audio decoding of the media content 102, video decoding of the media content 102, audio decoding of introductory content by Radio Jockey (RJ), and/or video decoding of introductory content by Video Jockey (VJ), and identify the type of media content based on the analyzed media content. Thereafter, based on the identified type of media content, the dynamic content adaptation system 108 may correlate the type of media content with the one or more type of media contents stored in the database 210 to identify if the media content 102 to be played is a potentially dangerous media content or not. The media content 102 is only rendered (after the delay) on the infotainment system 110 of the vehicle if the media content 102 is not mapped in the database 210 and if the media content 102 is mapped in the database 210 then the media content is either modified (such as reduction of volume) before playing or blocking from playing on the infotainment system 110 of the vehicle.

In an embodiment, a drive mode of the vehicle may be turned OFF, as shown by 506A in the interface 308 of FIG. 5C. It may be noted that when the drive mode of the vehicle is turned OFF, as shown by 506A, then playing the potentially dangerous media content (for driving) may not be significant since the vehicle is stationary/not moving. Accordingly, the dynamic content adaptation system 108 may include such potentially dangerous media content, i.e., Rap God, in the playlist being played on the infotainment system, as shown by 508A and/or render such potentially dangerous media content on the infotainment system of the vehicle. In another embodiment, the drive mode of the vehicle may be turned ON, as shown by 506B in the interface 308 of FIG. 5D. It may be noted that when the drive mode of the vehicle is turned ON, then playing the potentially dangerous media content, i.e., Rap God, should not be played since the playing such media content may lead to accidents because the vehicle is moving. Accordingly, the dynamic content adaptation system 108 may remove such potentially dangerous media content from the playlist being played on the infotainment system, as shown by 508B and/or block rendering of such potentially dangerous media content on the infotainment system of the vehicle. Accordingly, the dynamic content adaptation system 108 may be adaptable to modify rendering of the potentially dangerous media content based on the drive mode of the vehicle for the convenience of the user.

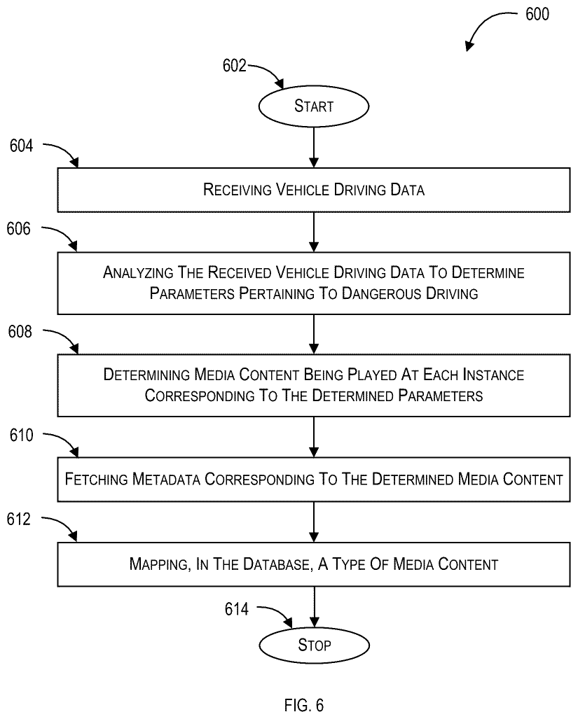

FIG. 6 is a flow chart 600 of a database management method for dynamic content adaptation for safe driving, in accordance with an embodiment of the present disclosure. The method starts at step 602.

At first, vehicle driving data may be received, at step 604. The vehicle driving data may correspond to speed, acceleration, deceleration, steering wheel movements, location, turn signal, brakes, horn, camera, collision sensors, and dippers. Next, at step 606, the received vehicle driving data may be analyzed to determine one or more parameters pertaining to dangerous driving. To determine the one or more parameters pertaining to dangerous driving, the database management method may include the steps of comparing the received vehicle driving data with normal vehicle driving data. The one or more parameters may include overspeeding, frequent lane changing, enabling collision warnings, sudden acceleration, frequent use of brakes, excessing honking, and/or excessive use of dippers. It may be apparent to a person skilled in the art that the normal vehicle driving data may dynamic and may depend on conditions such as, but not limited to, weather (e.g., different for rainy and sunny conditions), type of vehicle (e.g., different for off-roading vehicle and a sedan), congestion on road (e.g., different for traffic jams and clear roads), road conditions (e.g., different for smooth road and road with potholes), type of road (e.g., different for cities and highways), or the like.

Next, at step 608, media content being played at each instance corresponding to the determined one or more parameters may be determined. Upon determining the media content, metadata corresponding to the determined media content may be fetched, at step 610. Thereafter, a type of media content may be mapped in the database, at step 612, based on the fetched metadata with the determined one or more parameters for dynamic content adaptation to modify and/or block media content recommendations for safe driving. The type of media content corresponds to genre, singer, album, volume, intensity, title, duration, and/or repetitiveness. The method ends at step 614.

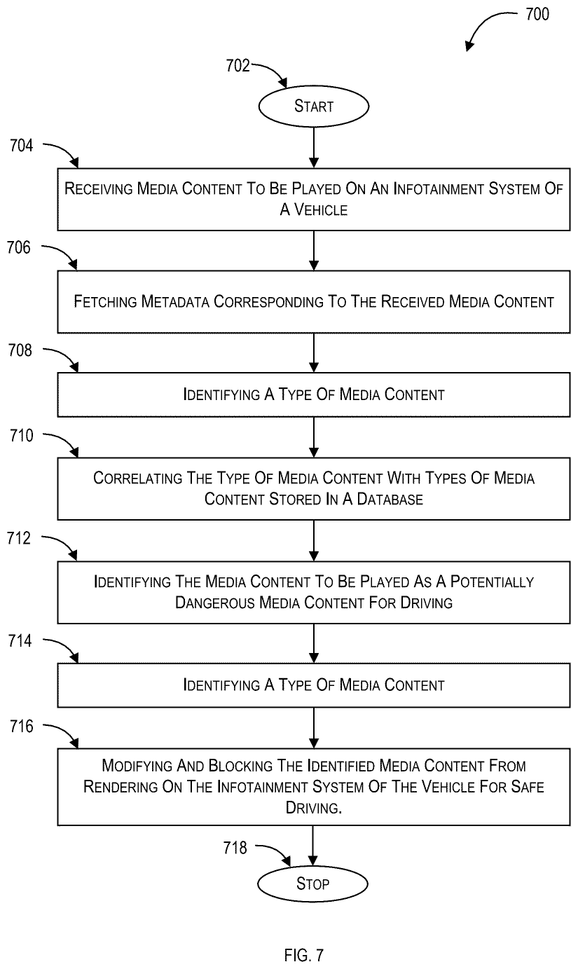

FIG. 7 is a flow chart 700 of a dynamic content adaptation method for safe driving, in accordance with an embodiment of the present disclosure. The method starts at step 702.

At first, media content to be played on the infotainment system of the vehicle may be received, at step 704. The media content may be received from a content provider, an Over-The-Top (OTT) platform, a content broadcaster, a third-party device, a Frequency Modulation (FM) broadcaster, and/or an Amplitude Modulation (AM) broadcaster. Upon receiving the media content, metadata corresponding to the received media content may be fetched, at step 706.

Next, at step 708, a type of media content may be identified based on the fetched metadata. In one scenario, when the media content is received from the content provider, the Over-The-Top (OTT) platform, the content broadcaster, and/or the third-party device, then the fetched metadata for identifying the type of media content includes embedded srt file, embedded teletext, title details, artist details, album details, genre details, time details, and/or intensity details. In another scenario, when the media content is received from the FM broadcaster and/or the AM broadcaster, then the dynamic content adaptation method may include the steps of adding a delay of a pre-defined time interval before the media content is played on the infotainment system of the vehicle. Upon adding the delay, the dynamic content adaptation method may analyze the media content by audio decoding of the media content, video decoding of the media content, audio decoding of introductory content by Radio Jockey (RJ), and video decoding of introductory content by Video Jockey (VJ). Thereafter, the dynamic content adaptation method may include the steps of identifying the type of media content based on the analyzed media content.

Upon identification of the type of media content, the type of media content may be correlated with one or more types of media content stored in the database, at step 710. Based on the correlation, the media content to be played may be identified as a potentially dangerous media content while driving, at step 712. Thereafter, the identified media content may be modified and/or blocked from rendering on the infotainment system of the vehicle for safe driving, at step 714. The modification of the identified media content before rendering on the infotainment system of the vehicle for safe driving may correspond to decreasing volume, increasing volume, increasing speed, decreasing speed, muting, skipping the identified media content, pausing, and/or stopping. The method ends at step 716.

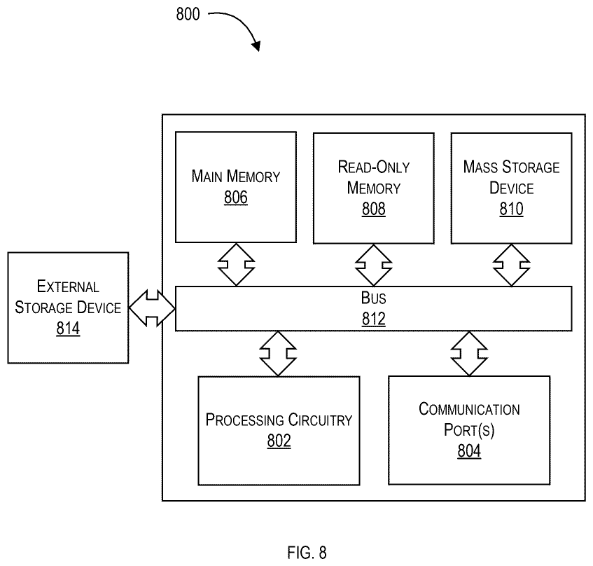

FIG. 8 illustrates an exemplary computer system in which or with which embodiments of the present disclosure may be utilized. As shown in FIG. 8, a computer system 800 includes an external storage device 814, a bus 812, a main memory 806, a read-only memory 808, a mass storage device 810, a communication port 804, and a processor 802.

Those skilled in the art will appreciate that computer system 800 may include more than one processor 802 and communication ports 804. Examples of processor 802 include, but are not limited to, an Intel® Itanium® or Itanium 2 processor(s), or AMD® Opteron® or Athlon MP® processor(s), Motorola® lines of processors, FortiSOC™ system on chip processors or other future processors. The processor 802 may include various modules associated with embodiments of the present disclosure.

The communication port 804 can be any of an RS-232 port for use with a modem-based dialup connection, a 10/100 Ethernet port, a Gigabit or 10 Gigabit port using copper or fiber, a serial port, a parallel port, or other existing or future ports. The communication port 804 may be chosen depending on a network, such as a Local Area Network (LAN), Wide Area Network (WAN), or any network to which the computer system connects.

The memory 806 can be Random Access Memory (RAM), or any other dynamic storage device commonly known in the art. Read-Only Memory 808 can be any static storage device(s) e.g., but not limited to, a Programmable Read-Only Memory (PROM) chips for storing static information e.g., start-up or BIOS instructions for processor 802.

The mass storage 810 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

The bus 812 communicatively couples processor(s) 802 with the other memory, storage, and communication blocks. The bus 812 can be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processor 802 to a software system.

Optionally, operator and administrative interfaces, e.g., a display, keyboard, and a cursor control device, may also be coupled to bus 804 to support direct operator interaction with the computer system. Other operator and administrative interfaces can be provided through network connections connected through communication port 804. An external storage device 810 can be any kind of external hard-drives, floppy drives, IOMEGA® Zip Drives, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the aforementioned exemplary computer system limit the scope of the present disclosure.

The disclosed system and method (together termed as ‘disclosed mechanism’) for dynamic content adaptation for safe driving overcomes the drawbacks of the present technologies and offers several other advantages in enhancing driving safety and reducing distractions caused by media content in the vehicles. By analyzing vehicle driving data and correlating it with media content metadata, the mechanism can proactively identify potentially dangerous content which allows for the modification or blocking of such content before it is played, reducing the risk of distractions and unsafe driving behaviors. Further, the mechanism's ability to dynamically adapt media content based on driving conditions promotes a safer driving environment. For example, the system can adjust the volume or speed of media content to minimize distractions without completely stopping the entertainment experience. This ensures that drivers remain engaged with the infotainment system while staying focused on the road. Additionally, the database of dangerous driving parameters and corresponding media content types can be continuously updated and refined which means that the mechanism can adapt to new types of media content or driving behaviors, ensuring that it remains effective in mitigating distractions and promoting safe driving practices over time. Overall, the mechanism's combination of data analysis, content identification, and adaptive control mechanisms offers a comprehensive solution for enhancing driving safety in vehicles with infotainment systems. It addresses the challenge of balancing entertainment and safety by providing a dynamic and proactive approach to managing media content during journeys.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

Thus, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices can exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art

What is claimed is:

1. A database management system for dynamic content adaptation for safe driving, the database management system comprises:
a receiver module to receive vehicle driving data;
an analyzer module to analyze the received vehicle driving data to determine one or more parameters pertaining to dangerous driving;
a content monitoring module to:
determine media content being played at each instance corresponding to the determined one or more parameters;
fetch metadata corresponding to the determined media content; and
a database building module to map, in a database, a type of media content based on the fetched metadata with the determined one or more parameters for dynamic content adaptation to at least one of: modify and block media content recommendations for safe driving.

2. The database management system of claim 1, wherein the vehicle driving data corresponds to at least one of: speed, acceleration, deceleration, steering wheel movements, location, turn signal, brakes, horn, camera, collision sensors, and dippers.

3. The database management system of claim 1, wherein the analyzer module is further configured to compare the received vehicle driving data with normal vehicle driving data to determine the one or more parameters pertaining to dangerous driving.

4. The database management system of claim 1, wherein the one or more parameters include at least one of: overspeeding, frequent lane changing, enabling of collision warnings, sudden acceleration, frequent use of brakes, excessing honking, and excessive use of dippers.

5. The database management system of claim 1, wherein the type of media content corresponds to at least one of: genre, singer, volume, intensity, title, duration, and repetitiveness.

6. A database management method for dynamic content adaptation for safe driving, the database management method comprises:
receiving vehicle driving data;
analyzing the received vehicle driving data to determine one or more parameters pertaining to dangerous driving;
determining media content being played at each instance corresponding to the determined one or more parameters;
fetching metadata corresponding to the determined media content; and
mapping, in a database, a type of media content based on the fetched metadata with the determined one or more parameters for dynamic content adaptation to at least one of: modify and block media content recommendations for safe driving.

7. The database management method of claim 6, wherein the vehicle driving data corresponds to at least one of: speed, acceleration, deceleration, steering wheel movements, location, turn signal, brakes, horn, camera, collision sensors, and dippers.

8. The database management method of claim 6, further comprises comparing the received vehicle driving data with normal vehicle driving data to determine the one or more parameters pertaining to dangerous driving.

9. The database management method of claim 6, wherein the one or more parameters include at least one of: overspeeding, frequent lane changing, enabling of collision warnings, sudden acceleration, frequent use of brakes, excessing honking, and excessive use of dippers.

10. The database management method of claim 6, wherein the type of media content corresponds to at least one of: genre, singer, volume, intensity, title, duration, and repetitiveness.

11. A dynamic content adaptation system for safe driving, the dynamic content adaptation system comprises:
a receiver module to:
receive media content to be played on an infotainment system of a vehicle; and
fetch metadata corresponding to the received media content;
a content identification module to identify a type of media content based at least on the fetched metadata;
a content blocking module to:
correlate the type of media content with one or more types of media content stored in a database;
identify the media content to be played as a potentially dangerous media content for driving based on the correlation; and
a rendering module to at least one of: modify and block the identified media content from rendering on the infotainment system of the vehicle for safe driving.

12. The dynamic content adaptation system of claim 11, wherein the media content is received from at least one of: a content provider, an Over-The-Top (OTT) platform, a content broadcaster, a third-party device, a Frequency Modulation (FM) broadcaster, and an Amplitude Modulation (AM) broadcaster.

13. The dynamic content adaptation system of claim 12, wherein when the media content is received from at least one of: the content provider, the Over-The-Top (OTT) platform, the content broadcaster, and the third-party device, then the fetched metadata for identifying the type of media content includes at least one of: embedded srt file, embedded teletext, title details, artist details, genre details, time details, and intensity details.

14. The dynamic content adaptation system of claim 12, wherein when the media content is received from at least one of: the FM broadcaster and the AM broadcaster, then the content identification module is further configured to:
add a delay of a pre-defined time interval before the media content is played on the infotainment system of the vehicle;
analyze the media content by at least one of: audio decoding of the media content, video decoding of the media content, audio decoding of introductory content by Radio Jockey (RJ), and video decoding of introductory content by Video Jockey (VJ); and
identify the type of media content based on the analyzed media content.

15. The dynamic content adaptation system of claim 11, wherein modifying the identified media content before rendering on the infotainment system of the vehicle for safe driving corresponds to at least one of: decreasing volume, increasing volume, increasing speed, decreasing speed, muting, skipping the identified media content, pausing, and stopping.

16. The dynamic content adaptation system of claim 11, wherein the database is built by a database management system by:
receiving vehicle driving data;
analyzing the received vehicle driving data to determine one or more parameters pertaining to dangerous driving;
determining media content being played at each instance corresponding to the determined one or more parameters;
fetching metadata corresponding to the determined media content; and
mapping, in the database, a type of media content based on the fetched metadata with the determined one or more parameters for dynamic content adaptation to at least one of: modify and block media content recommendations for safe driving.

17. The dynamic content adaptation system of claim 16, wherein the vehicle driving data corresponds to at least one of: speed, acceleration, deceleration, steering wheel movements, location, turn signal, brakes, horn, camera, collision sensors, and dippers.

18. The dynamic content adaptation system of claim 16, wherein the analyzer module is further configured to compare the received vehicle driving data with normal vehicle driving data to determine the one or more parameters pertaining to dangerous driving.

19. The dynamic content adaptation system of claim 16, wherein the one or more parameters include at least one of: overspeeding, frequent lane changing, enabling of collision warnings, sudden acceleration, frequent use of brakes, excessing honking, and excessive use of dippers.

20. The dynamic content adaptation system of claim 16, wherein the type of media content corresponds to at least one of: genre, singer, volume, intensity, title, duration, and repetitiveness.
